(19) United States
(12) Patent Application Publication
(10) Pub. No.: US 2004/0044999 A1
(43) Pub. Date: Mar. 4, 2004

(54) Subscription-based program module installation and update system and method

(76) Inventor: Mason C. Gibson, Cocoa Beach, FL (US)

Correspondence Address: Dergosits & Noah LLP, Suite 1450, Four Embarcadero Center, San Francisco, CA, 94111, US

(21) Appl. No.: 10/231,965

(22) Filed: Aug. 30, 2002

(51) Int. Cl. G06F 9/445; G06F 9/44

(52) U.S. Cl. 717/178; 717/173

(57) ABSTRACT

A system for automatically updating program modules on a plurality of computers coupled to a server computer in a large-scale distributed network is described. In a network comprising disparate types of server computers, target server computers are first divided into logical groups based on server functionality. File updates are made available on a master update server. The master update server advertises the availability to the target servers. The master update server creates an advertising message and transmits or otherwise makes available the advertising message to the target server computers. Each target server computer determines whether the update is to be performed. If an update is to be performed, the target server computer accesses the file location of the update file specified in the advertising message and downloads the update program. If an update is not be performed, a decline message is transmitted to the update server. The update module is installed on the target server computer in accordance with a pre-defined update schedule. A certified communications protocol encoding a registered serial number of the update server is utilized to facilitate verification of the update server identity to the target server computer.

### FIELD OF THE INVENTION

The present invention relates generally to computer networks, and more specifically, to a system for automatically updating program modules in client/server networks.

### BACKGROUND OF THE INVENTION

Large businesses and organizations often employ large-scale computer networks to store and process the data involved in the operation of the organization. These enterprise networks are often geographically dispersed networks that are under the jurisdiction of the organization, and typically include several different types of networks and computer systems from different vendors. Enterprise management systems are often used to manage and administer such geographically disperse networks. Typically, the networking infrastructure in a large enterprise with multiple computer systems and networks of different types is very complex. Many different applications are involved, each one possibly requiring different user interfaces, and/or application program interfaces. Because of the complexity and different requirements, much programming of these systems does not directly involve any real data processing of the product or services that the organization provides. Instead, a great deal of effort is spent on integrating and managing the disparate networks and systems, and developing additional interfaces as needs and applications change.

While initially implementing enterprise management systems is a difficult enough task in itself, maintaining these systems is often an even greater challenge. In a dynamic organization, not only is operational data modified on a constant basis, but applications, program modules, interfaces, and other such infrastructure components may also change on a frequent basis. In order to ensure that the enterprise system continues to operate as a cohesive network, any updates to operational program modules must be made to all of the relevant computers in a timely manner. Updating program modules and interface components is thus a critical aspect of enterprise management software systems. Keeping up with application updates and changes necessitated by changing business processes is a significant task for system administrators, and the additional burden of maintaining the system administration tools often creates a very difficult situation.

One disadvantage of present enterprise management systems is that they typically do not provide a way to update multiple server computers with minimal processing overhead or user interaction. Typically updates are performed on present systems through a polling process in which a central server or other central resource indicates to system administrators that an update is available and required to be downloaded. The system administrators then access the central server, download the appropriate modules, and install the modules on the target server computers. This requires a great deal of administrative attention and process steps.

Another disadvantage associated with present enterprise management systems is that they often lack adequate systems for efficiently monitoring system events and consistently managing these events to reduce server support problems.

What is needed, therefore, is an enterprise management system that provides an efficient and centralized method of updating application programs, interfaces, and other program modules to distributed server computers in a distributed network.

What is further needed is an enterprise management system that provides effective diagnostic reporting capability in the event of module update failures or anomalous conditions.

What is further needed is a security protocol that enables critical messages to be transferred among networked computers without requiring third party secured communication protocols to enable secure communications channels.

### SUMMARY OF THE INVENTION

A system for automatically updating program modules on a plurality of computers coupled to a server computer in a large-scale distributed network is described. In a network comprising disparate types of server computers, target server computers are first divided into logical groups based on server functionality. File updates are made available on a master update server. The master update server advertises the availability to the target servers. The master update server creates an advertising message and transmits or otherwise makes available the advertising message to the target server computers.

Each target server computer determines whether the update is to be performed. If an update is to be performed, the target server computer accesses the file location of the update file specified in the advertising message and downloads the update program. If an update is not to be performed, a decline message is transmitted to the update server. The update module is installed on the target server computer in accordance with a pre-defined update schedule.

In one embodiment, a certified communications protocol encoding a registered serial number of the update server is utilized to facilitate verification of the update server identity to the target server computer.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a network that implements a program module update system, according to one embodiment of the present invention;

FIG. 2 is a flowchart that illustrates the general steps of configuring a network for operation with an enterprise management system, according to one embodiment of the present invention;

FIG. 3 is a flowchart that illustrates the general steps of updating a program module in an enterprise management system, according to a method of the present invention;

FIG. 4 is a flowchart that illustrates the steps of advertising a program update, according to one embodiment of the present invention;

FIG. 5 is a flowchart that illustrates the steps of downloading an advertised program update, according to one embodiment of the present invention;

FIG. 6 is a flowchart that illustrates the steps of auto-updating a downloaded program update, according to one embodiment of the present invention;

FIG. 7 is a flowchart that illustrates the steps in implementing a certified communications protocol, according to one embodiment of the present invention;

FIG. 8 illustrates the layout of a message utilizing a certified communications protocol, according to one embodiment of the present invention; and

FIG. 9 is a flowchart that illustrates the steps in receiving and processing a certified communications protocol transmitted advertisement message, according to one embodiment of the present invention.

### DETAILED DESCRIPTION OF THE PREFERRED EMBODIMENT

A program module update system for enterprise management systems is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented by one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, or any other similar type of computing device.

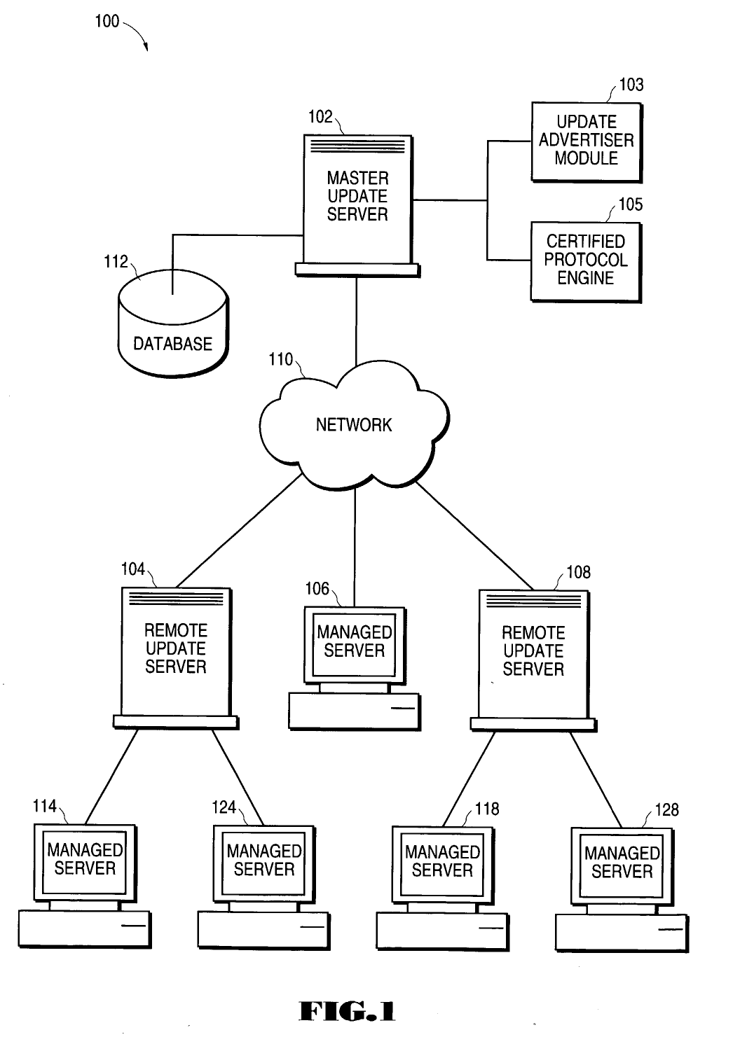

In a large-scale distributed network that implements enterprise management system software, or similar system programs, updating administrative program modules and interfaces is a crucial, and often time and labor intensive task. FIG. 1 illustrates a network that implements an automated and centralized program module update system, according to one embodiment of the present invention. Network 100 consists of a central master update server 102 that is linked to multiple other computers through network 110. The master update server 102 makes available to the other networked computers any module updates or revisions that may need to be implemented by the other computers. An update advertiser module 103 executed by the master update server 102 advertises any pending module updates to the network. The update advertising process is performed using a certified protocol managed by a certified protocol engine 105 also executed by the master update server 102. In a multi-tiered embodiment of the program module update system, the master update server 102 is coupled through network 110 to one or more remote update servers 104 and 108. Each remote update server is, in turn, coupled to one or more managed servers. Thus, as shown in FIG. 1, remote update server 104 is coupled to managed servers 114 and 124, and remote update server 108 is coupled to managed servers 118 and 128. A managed server can also be connected to the master update server 102 through a direct network link, such as managed server 106. Each managed server executes an administration client module that processes the messages provided by the master update server 102 and performs the update operations.

The master update server 102 advertises the availability of a program update to all of the participating managed servers. Each managed server then determines whether the posted update should be implemented on that particular machine. If the update is to be made, the managed server pulls the update down from the master update server automatically. During normal system administration processing, the system update is performed on each of the targeted managed servers that are to be updated. If an update fails, an alarm is generated and transmitted to the system administrator. In this manner, a single download to the master update server 102 can be propagated through the entire network of managed servers with minimal operator involvement.

The computers illustrated in network 100 illustrated in FIG. 1 could comprise any class of computer, including personal computers, laptop computers, mainframe computers, or even networkable handheld computing devices, such as wireless personal digital assistant (PDA) devices, and the like. In one embodiment, the network 100 comprises a Unix platform consisting of Unix operating system computers, such as Data General DG/UX, Hewlett-Packard HP-UX, IBM AIX, SCO Open Server, Sun Solaris, or similar computers. Alternatively, the network may utilize the Linux operating system and consist of Linux compatible computers, such as Caldera, Red Hat, SuSE and TurboLinux. Although the targeted computers that receive the update message from the master update server 102 in FIG. 1 are referred to as “managed servers”, it should be understood that these computers may also be configured to perform as either server or client computers within network 100. When configured as a server computer, it is assumed that each of the managed servers is coupled, in turn, to one or more client computers (not shown).

In one embodiment, communication between the computers in network 100 is accomplished using a secure, encrypted, and certified protocol defined by the certified protocol engine. The master update server 102 can only advertise an update. Each managed server accesses the advertised update message and determines if a download is authorized. The certified protocol allows each managed server to certify that the request is from the recognized master update server. Each managed server downloads or declines an advertised update, and determines when to install the update based on a configured window of allowable time. All update events, including update advertisements, managed server downloads or decline messages, error reports, and any other administrative reports and events are logged and stored in a memory location, such as in database 112.

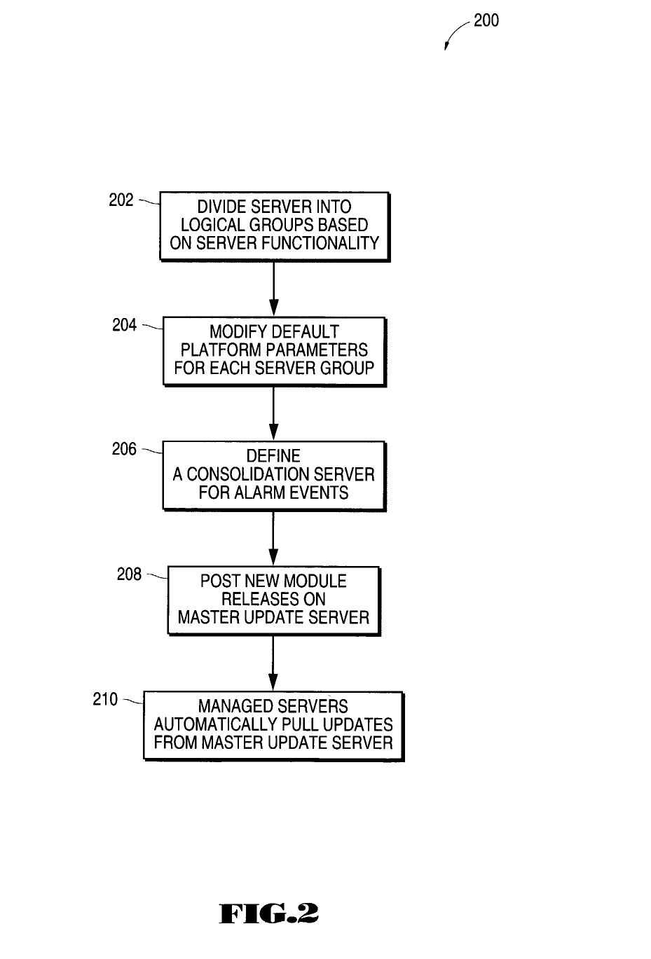

FIG. 2 is a flowchart that illustrates the general steps of configuring a network for operation with an enterprise management program update system, according to one embodiment of the present invention. As a preliminary step 202, a system administrator responsible for administering a geographically dispersed population of mixed servers may first divide the server population into logical server groups based on server functionality. For example, servers can be grouped into functions such as, electronic mail (e-mail) servers, database servers, development servers, and so on, to the extent that different servers within the network are configured to perform these different types of tasks. Once the servers are grouped by function, the default platform parameters are defined for each group, step 204.

In step 206, a consolidation server is defined that consolidates alarm events for larger locations that have an on-site administrator. This server acts to notify the local administrator of problems at their location. Servers at remote locations that do not have an administrator are configured to send their alarms to a centralized management location, such as master update server 102 for remote monitoring. The consolidation server is generally configured as the remote update server 104 and 108 for program updates. The remote servers 104 and 108 act as local system administrators for the remote locations of managed servers, such as server pairs 114/124, and 118/128. Alarm events from these remote locations with remote update servers can be configured to copy and/or escalate alarms to the central management location using specific scripts or program commands.

As new programs, modules, user interfaces, or any updateable components of the system administration network are created, these updates are posted on the master update server 102, step 208. The managed servers then automatically pull the updates from the master update server, step 210.

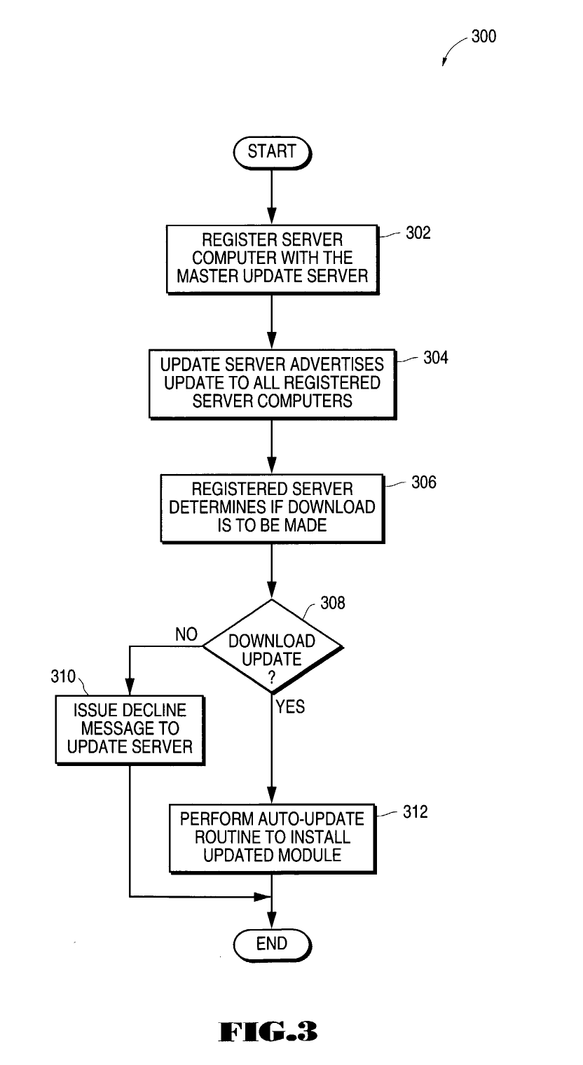

The update publication process is divided into three general phases. During the first phase the central update server advertises the update to all the managed servers registered to the update server 102. During the second phase, each managed server decides if it needs to download the update or to decline it. If the update is to be downloaded, in the third phase, the client performs an auto-update procedure to install the downloaded update module. FIG. 3 is a flowchart that illustrates the general steps of updating a program module in an enterprise management program update system, according to a method of the present invention. To provide a self-contained and comprehensive managed server network system, participating managed servers must be registered with a central authority. Thus, a preliminary step in the process is to register each participating managed server with the master update server, step 302. Each registered server can also be referred to as a “target” server or computer.

In step 304, the master update server advertises the update to all registered managed server computers. Each registered managed server then determines whether or not to perform an update operation using the advertised update module, step 306. Thus, in step 308 it is determined whether the managed server will download (pull) the update module from the master update server. If the update module is not to be downloaded and installed, the managed server issues a decline message to the master update server, step 310. Otherwise, the managed server downloads the update module, and performs an auto-update step to install the updated module, step 312.

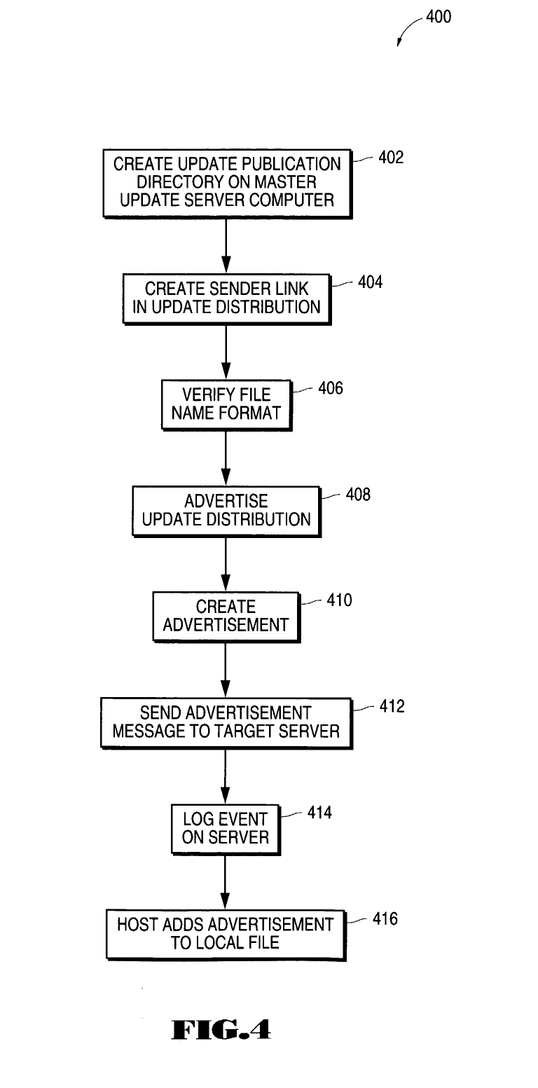

A main step in the flowchart of FIG. 3 is the advertisement step 304 performed by the master update server. FIG. 4 is a more detailed flowchart that illustrates the steps of advertising a program update, according to one embodiment of the present invention. In step 402, an update publication directory is created on the master update server. For each file in this update publication directory, a sender link is created in the update distribution, step 404. Prior to advertisement, the file name format is verified, step 406. For example, the file name could comprise an alphanumeric string consisting of various control characters and names, as well as the version number of the update, the platform code (of the target managed server), and other such characters. The platform code could comprise a three-character extension such as: “lnx” for Linux systems, “unx” for Unix systems, “dec” for Digital Equipment systems, and so on. If the file name does not fit the pattern it is removed from the update directory.

In one embodiment, the file name of the update program itself can be coded as a symbolic link. In this case, the source for the symbolic link is obtained and a new symbolic link is created with the file name, such as “distributions/<file-name>_<sender-name>”. If the file name is not a symbolic link, the file name is hard linked as “distributions/<file-name>_<sender-name>”. For each file in the “distributions” directory, the distribution is advertised through a message sent to each of the intermediate servers and/or directly linked managed servers. Alternatively, the advertisement message can simply be posted to an accessible area on the master update server, and each of the intermediate servers and managed servers can poll this location to determine the presence of an advertisement message. Each server that receives the advertised message parses the file name to get the update version number, the platform code, and the host name from which to receive the advertisement.

In step 410, the advertisement message is created. The advertisement message consists of the following data fields: time stamp (year, Julian day, hour, minutes, seconds), serial number of the master update server, version number of the update module, platform code, checksum and size of the advertisement file, and the file name to download or decline. Once the advertisement message is created, it is sent to each target managed server, step 412, and the event is logged, step 414. Each managed server (host) will then add the advertisement to a local update file, step 416.

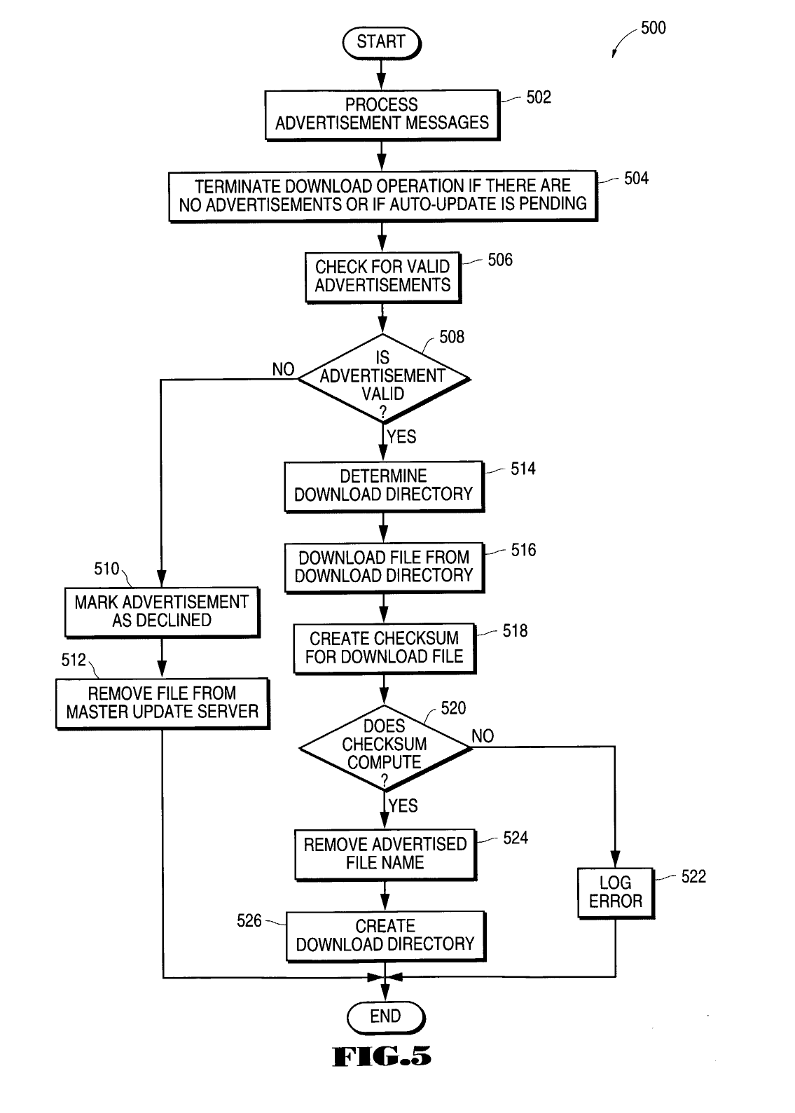

Once the advertisement message is created and advertised, the advertisements are processed so that the targeted server computers can download the updated program module or modules. FIG. 5 is a flowchart that illustrates the steps of downloading an advertised program update, according to one embodiment of the present invention. In step 502, the target server checks for the presence of an update directory and processes whatever advertisement messages may be present. The update directory is typically located in a memory location of the master update server 102, or it may be located in a remote memory location accessible to the master update server. The download operation is terminated if there are no advertisements, step 504. This can occur if the update directory does not exist or is empty (no advertisements). The download phase is also terminated if another update operation is currently pending.

In step 506, the target server checks the update directory for valid advertisement messages. All records in the update directory, beginning with the last record and reading backwards, are processed until a download occurs or the records are exhausted. If a valid advertisement is not found, as determined in step 508, the advertised message is declined, step 510, and the advertisement is removed from the master update server, step 512. The download can also be declined if the update function is disabled on the target server. Other conditions that can be used to invalidate an advertisement include, if the master update server's address and serial number cannot be certified, or if it is not authorized with the “publish” option. Other decline conditions include: if the advertised platform does not match the target server platform, or if the advertised version is earlier than the current version on the target server, or if the advertised version is equal to the current version and the advertised checksum equals the last update checksum.

If, in step 508, it is determined that the advertisement is valid, the download directory on the target server is determined using the advertised size and the available space in each local file system, step 514. In step 516, the advertised file is downloaded from the download directory. The system then creates a checksum for the download file, step 518. In step 520 it is determined if the download file checksum and advertised checksum are the same. If the checksums are different, an error message is logged, and the download file is removed and the download phase terminated, step 522. If the checksums do match, advertised file name is removed from the master update server, step 524. A download directory is then created, step 526, and the download phase is terminated.

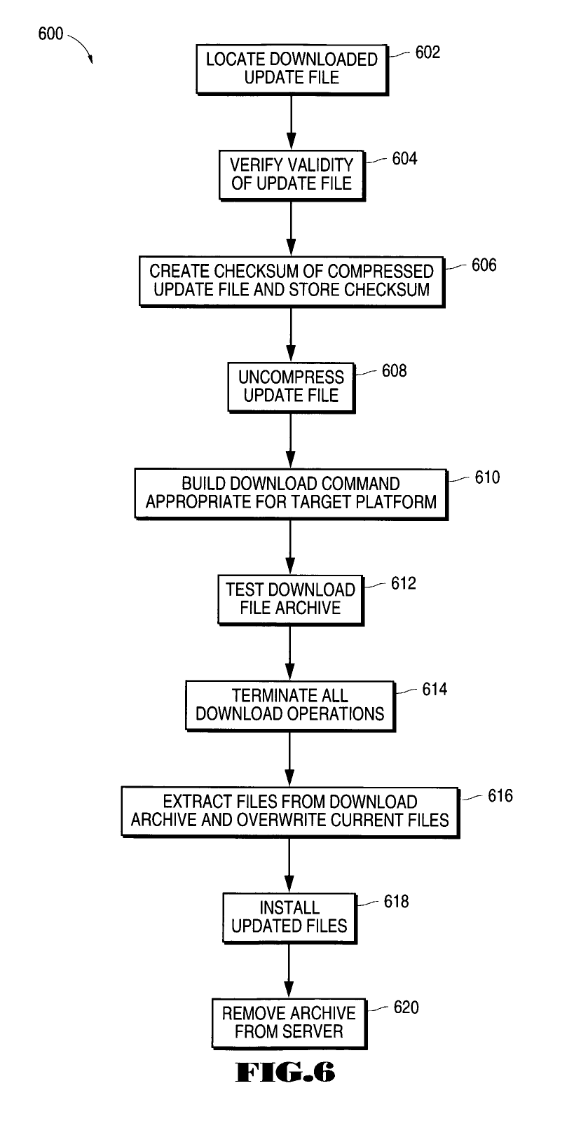

Once a valid update file is downloaded, the targeted server performs an auto-update procedure to implement the update. FIG. 6 is a flowchart that illustrates the steps of auto-updating a downloaded program update, according to one embodiment of the present invention. In step 602, the target server accesses the directory in which the update is installed to locate the downloaded update file. In step 604, it is verified that a valid update file archive is in the directory location. A checksum of the compressed update file is then created and stored, step 606. For Unix based files, the update file may have been created as an archive using the Unix “tar” tape archive command. In this case, the archive of the update file is uncompressed, step 608. The checksum can be stored in a common directory so that it can be used to decline future advertisements. In step 610, the target server builds an archive command appropriate for the platform. The archive is then tested to ensure that no error will be encountered when the files are extracted from the archive, step 612. In step 614, all download operations are terminated, and held for a period of time, e.g., five minutes, to ensure that all administration processes terminate. In step 616, the target server extracts all files from archive and overwrites current files. The update file or files are then installed, step 618, and the archive is removed, step 620.

In one embodiment of the present invention, the target managed server can be configured to download the advertised update during a pre-defined time window, such as every first Sunday at 11:00 p.m., or any other similar time frame. The automated advertisement of the update message from the master update server, and the automatic verification and download operation performed by the targeted managed servers facilitates a streamlined and robust update scheme for program modules among networked computers that requires little or no operator involvement. Such a scheme is enhanced by a unique security protocol that ensures that update message and transmissions are validated and occur only for registered computers within the network.

In one embodiment of the present invention, a secure communications protocol is employed for the transfer of data between the master update server 102 and the intermediate and managed servers illustrated in FIG. 1. This protocol, referred to as the “certified communication protocol” allows the servers to exchange information over a private, encrypted TCP/IP socket. A default socket number, e.g., “51692” is established for secure communication among the servers. A sending server (“sender”) can request that a receiving server (“receiver”) run a command and send the output back to the sender. The sender can also pull a file from the receiver. Each server can act as either a sender or receiver, thus allowing for bi-directional secure communication.

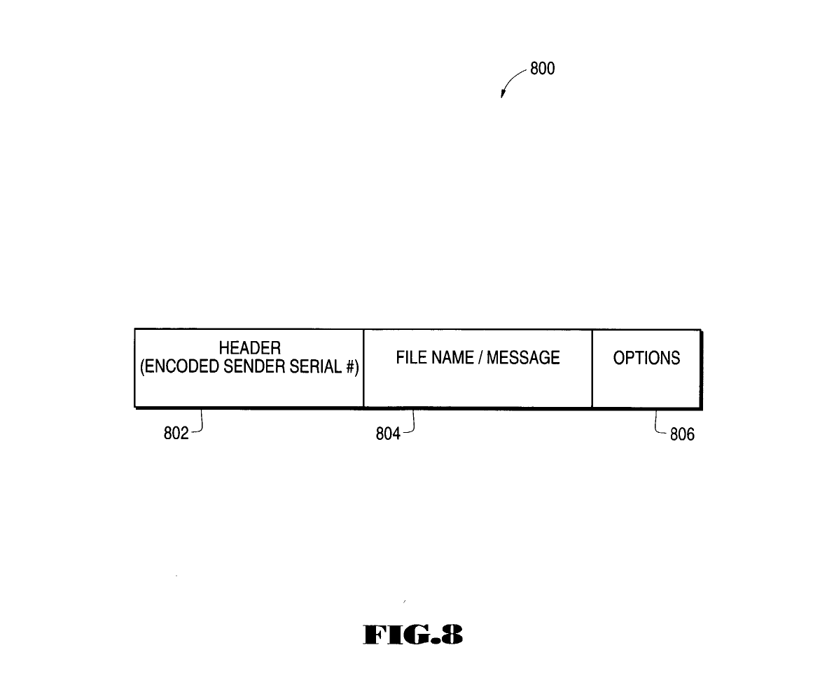

In one embodiment, all messages sent over the socket are encrypted using the Advanced Encryption Standard (AES). The key length is typically set to 128 bits, but can be set to other lengths as well. A message transmitted using the certified communications protocol adheres to a specific data format. FIG. 8 illustrates the layout of a message utilizing a certified communications protocol, according to one embodiment of the present invention. The message 8 consists of a header 802, followed by a file name or message field 804, and an options field 806. The header 802 includes an encoded string that represents the serial number of the sending server, e.g., the master update server. The receiving server must have this serial number registered in a network matrix. After decrypting the message, if the sender serial number can be certified, the receiver executes the command in the message 804. Other encoded datagrams may also be included that must be verified in addition to the serial number. For example, in one embodiment, a specific alpha-numeric string, such as one or two character code and referred to as a “control number”, is encoded is a specific bit location of the header. Executed commands are logged in a receiver log.

In one Unix-based implementation, the sender can only be run by the super user and requires no configuration. The receiver must be configured to authorize the sender's requests. This configuration is done in the <<RECEIVER>> section of the network matrix. A sender variable defines the sender's host name, the sender's serial number and any relevant options. If the serial number is defined to be “unknown”, the receiver will fill in the correct value during the first connection. Every request sent by a sender contains its encrypted serial number. This allows the receiver to certify that the request is coming from that host and not a spoofed host. The receiver's log can be used to determine what host name a sender is seen as since this log records connection failures as well as connection successes.

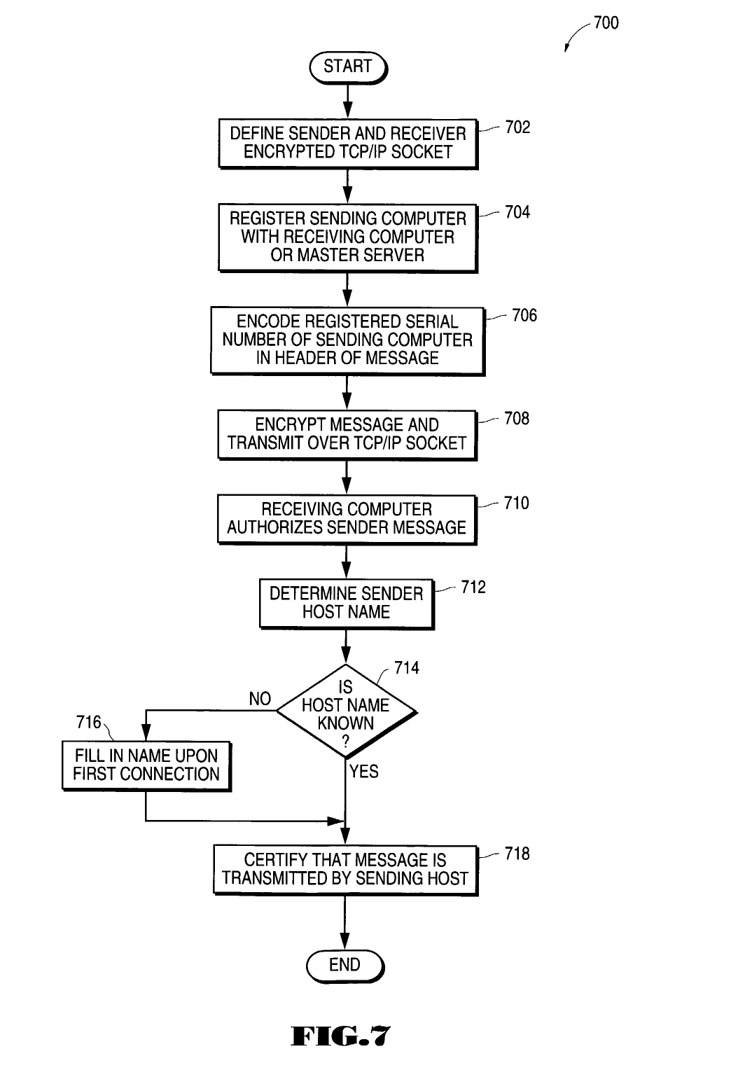

FIG. 7 is a flowchart that illustrates the steps in implementing a certified communications protocol, according to one embodiment of the present invention. In step 702, the sender and receiver TCP/IP socket is defined. The sending computer and receiving computers are then registered with each other, or a central server resource, step 704. In step 706, the serial number, and any relevant options, such as platform, user status, and so on are encrypted into the header portion of the message. The control number is also encoded in the header portion 802 of the message. The message is then encrypted using a standard or proprietary encryption standard and transmitted over the secure socket, step 708. In step 710, the receiving computer receives and authorizes the sender message. The receiver unpacks the message and determines the sender's serial number from the header information, step 712. The receiver also verifies that the control number is present and in the correct bit location of the message. In step 714, it is determined whether or not the sender's serial number is known. If not, the serial number is filled in upon first connection between the sender and receiver. The receiver then certifies that the message was transmitted by the sending host, step 718.

The incorporation of the encrypted sender serial number and unique randomly selected control number in the header of the message ensures that effective spoofing of the host by an unauthorized third party is very difficult, and thus provides a high degree of security, with minimal programming overhead.

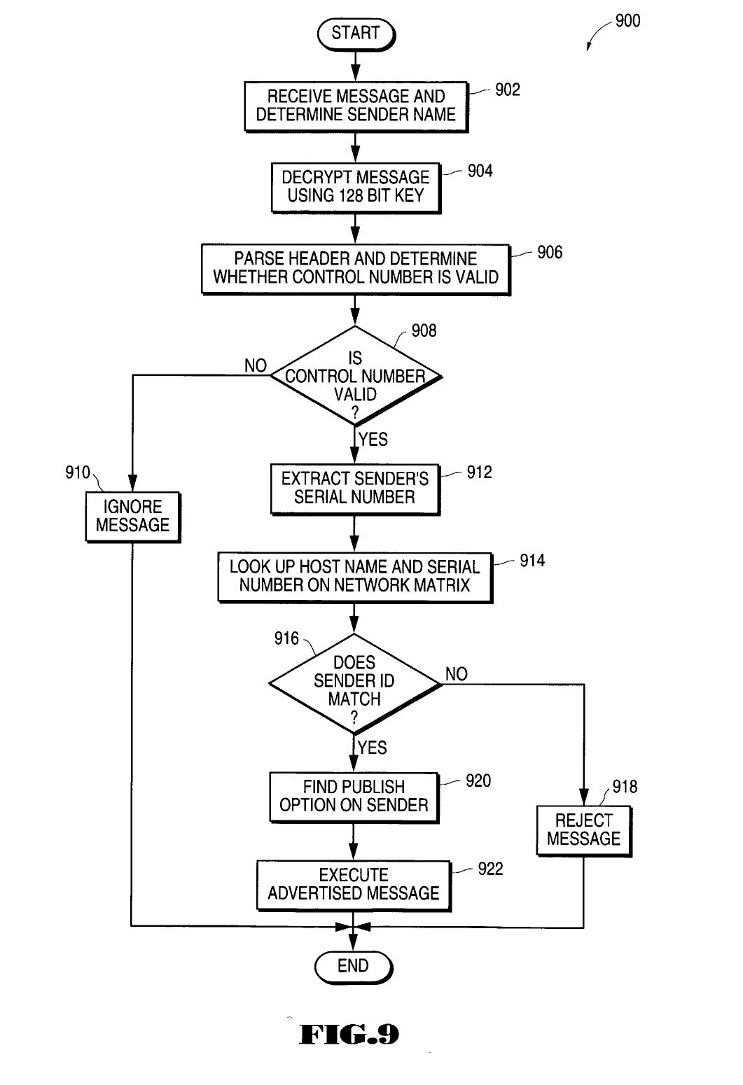

FIG. 9 is a flowchart that illustrates the steps in receiving and processing a certified communications protocol transmitted advertisement message, according to one embodiment of the present invention. In step 902, the receiver, such as a managed server or intermediate remote update server, receives the transmitted message from the master update server 102. Such a message could comprise an advertisement message indicating the availability of an update module from the master update server, and corresponds to the format illustrated in FIG. 8. In many network protocols, such as TCP/IP, the name or other network ID for the sender is indicated in the message. For such protocols, the receiver determines the sender's host name or ID. The receiver next decrypts the message using shared secret 128-bit key, step 904.

In step 906, the receiver parses the header portion 802 of the message and determines whether the control number is valid. This is accomplished by verifying that the control number string is correct and in the proper location of the header. In one embodiment, the control number can be determined during the registration process between the master update server and the target managed servers. If, in step 908, it is determined that the control number is not present or is incorrect, the message is ignored, step 910, and the process ends. If the control number is valid, the receiver extracts the sender's serial number from the header, step 912. In step 914, the receiver looks up the sender host name and serial number on a network matrix or similar database. In step 916, the receiver determines whether the serial number and host name match the information provided in the database. If not, the message is rejected, step 918, and the process ends. If the sender ID information does match, the receiver locates the publish option in the update directory of the master update server, step 920. The receiver then executes the advertisement message to download or otherwise access the program update, step 922.

In one embodiment of the present invention, a system administration graphical user interface (GUI) is provided through the master update server 102. This interface provides a consistent input and display context in which to control and support a possibly heterogeneous server population. The GUI includes an update control panel that is a configuration component that allows changes to be made to operational parameters for multiple types of servers. The control panel provides access to various software controls such as a configuration manager, alarms monitor console, event logger, data archiver, and other similar functions.

In a Unix/Linux network platform, the control panel GUI can be implemented as an X-windows session. Alternatively, the control panel, and/or any of the sub-windows within the GUI can be implemented as web pages using HTML protocols.

Although embodiments of the present invention have been described with reference to a network implementation comprising the Unix type computers, it should be noted that alternative embodiments of the present invention can be implemented on many other types of networks and network protocols, such as proprietary protocols for local area networks, wide area networks, and any combination thereof.

Furthermore, although embodiments of the present invention have been described with reference to the distribution of software or program update modules, it should be noted that alternative embodiments of the present invention can be used for any type of distributed software module or program, that is capable of being downloaded between networked computers.

In the foregoing, a system has been described for processing program updates over a large-scale distributed network. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of automatically updating one or more software components on a plurality of target computers from a server computer, the method comprising the steps of:
identifying target computers of the plurality of target computers as registered target computers by verifying a registration status with the server computer;
transmitting an advertisement message from the server computer to each of the registered target computers, the advertisement message indicating that a software module update is available;
determining, on each of the registered target computers, if the software module update is an authorized update;
certifying, on each of the registered target computers that determines to implement the software module update, the software module update request to the server computer;
downloading, to each of the registered target computers, the software module update from a database location specified by the server computer, for each registered target computer that certifies the software module update request;
declining the advertised update and transmitting a decline message to the server computer for each registered target computer that does not certify the software module update request;
installing the software module update on each registered target computer that certifies the software module update request, based on a pre-defined time schedule; and
transmitting an alarm alert to the server computer for each update operation that is not successfully completed.

2. The method of claim 1 further comprising the steps of:
registering an identifier number associated with the server computer with each target computer of the plurality of target computers;
encoding the identifier number in a header of the advertisement message transmitted from the server computer to each target computer; and
verifying, in each target computer, the identifier number of the server computer.

3. The method of claim 1 further comprising the step of logging each update operation that is successfully completed in a database accessible to the server computer.

4. The method of claim 2 wherein the advertisement message comprises the header, a file name field specifying a name of the software module update, and an options field specifying parameters regarding an update operation.

5. The method of claim 2 further comprising the step of encoding an alphanumeric string in a predefined location within the header.

6. The method of claim 5 further comprising the steps of:
encrypting the advertisement message prior to transmission from the server; and
decrypting the advertisement message after reception by each target computer.

7. The method of claim 6 wherein the advertisement message is encrypted using public key/private key encryption system.

8. The method of claim 7 wherein each target computer receiving the advertisement message decrypts the advertisement message with a 128-bit key and verifies that the alphanumeric string is present in the predefined location within the header.

9. A method distributing software programs over a network coupling a server computer to a plurality of client computers, the method comprising the steps of:
creating an update publication directory on the server computer;
storing one or more files comprising a software program update in the update publication directory;
creating an advertisement message indicating the availability of a software program update for installation by one or more of the plurality of client computers;
incorporating a link to the update publication directory within the advertisement message;
transmitting the advertisement message to the plurality of client computers;
receiving the advertisement message in a target client computer of the plurality of client computers;
determining a sender identification of the server computer from the advertisement message;
validating the sender identification by performing a comparison of the sender identification determined from the advertisement message with a pre-stored sender identification; and
accessing the one or more files comprising the software program update from the update publication directory on the server computer if the sender identification determined from the advertisement message matches the pre-stored sender identification.

10. The method of claim 9 further comprising the steps of:
creating, on the target client computer, a download directory;
downloading the one or more files from the update publication directory to the download directory on the target client computer; and
installing the one or more files to perform a software update operation.

11. The method of claim 10 wherein the step of downloading the one or more files is automatically performed at a pre-determined time defined by the target client computer.

12. The method of claim 10 wherein the step of installing the one or more files is automatically performed at a pre-determined time defined by the target client computer.

13. The method of claim 9 further comprising the step of dividing the client computers into one or more functional groups of the client computers depending upon tasks performed by client computers within a functional group.

14. The method of claim 10 wherein the one or more functional groups comprise at least one of: database functions, electronic mail functions, and system administration functions.

15. The method of claim 9 further comprising the step of incorporating a link to the one or more files comprising the software program update within the advertisement message.

16. The method of claim 9 further comprising the steps of:
rejecting the advertisement message if the sender identification determined from the advertisement message does not match the pre-stored sender identification; and
transmitting an error message to the server computer upon rejection of the advertisement message.

17. The method of claim 10 further comprising the steps of:
creating a log message for each successful software update operation; and
storing the log message in a database coupled to the server computer.

18. The method of claim 9 wherein the advertisement message comprises a header field including a serial number of the server computer, and a message field including a reference to the one or more files comprising the software program update.

19. The method of claim 10 further comprising the step of registering the target client computer with the server computer and the server computer with the target client computer by establishing a common encryption scheme, defining a unique control number known to both the target client computer and the server computer, and defining a unique network identifier for each of the server computer and target client computer.

20. The method of claim 19 further comprising the steps of:
encoding the control number within the header of the advertisement message;
encrypting, in the server computer, the advertisement message using the common encryption scheme;
decrypting, in the target client computer, the encrypted advertisement message; and
validating the control number in the header.

21. The method of claim 20 wherein the encryption scheme comprises a 128-bit key public key/private key encryption system.

22. The method of claim 19 wherein the unique network identifier for the server computer corresponds to the sender identification of the server computer, and includes a serial number of the server computer.

23. The method of claim 22 wherein the step of validating the sender identification comprises the steps of:
determining, on the target client computer, a network address of the server computer;
correlating the network address of the server computer with the serial number of the server computer decrypted from the header of the advertisement message using the pre-stored sender identification.

24. The method of claim 23 wherein the network implements a TCP/IP protocol, and wherein the network address of the server computer is transmitted in conjunction with the advertisement message to the target client computer.

25. An apparatus for distributing software programs over a network coupling a server computer to a target client computer, the apparatus comprising:
means for creating an update publication directory on the server computer;
means for storing one or more files comprising a software program update in the update publication directory;
means for creating an advertisement message indicating the availability of a software program update for installation by the target client computer;
means for incorporating a link to the update publication directory within the advertisement message;
means for transmitting the advertisement message to the target client computer;
means for receiving the advertisement message in the target client computer;
means for determining a sender identification of the server computer from the advertisement message;
means for comparing the sender identification determined from the advertisement message with a pre-stored sender identification to validate the advertisement message; and
means for accessing the one or more files comprising the software program update from the update publication directory on the server computer if the sender identification determined from the advertisement message matches the pre-stored sender identification.

26. The apparatus of claim 25 further comprising:
means for creating a download directory on the target client computer;
means for downloading the one or more files from the update publication directory to the download directory on the target client computer; and
means for installing the one or more files to perform a software update operation on the target client computer.

27. The apparatus of claim 25 further comprising an incorporated link to the one or more files comprising the software program update within the advertisement message.

28. The method of claim 25 further comprising:
means for rejecting the advertisement message if the sender identification determined from the advertisement message does not match the pre-stored sender identification; and
means for transmitting an error message to the server computer upon rejection of the advertisement message.

29. The apparatus of claim 26 further comprising:
means for creating a log message for each successful software update operation; and
means for storing the log message in a database coupled to the server computer.

30. The apparatus of claim 25 wherein the advertisement message comprises a header field including a serial number of the server computer, and a message field including a reference to the one or more files comprising the software program update.

31. The apparatus of claim 26 further comprising means for registering the target client computer with the server computer and the server computer with the target client computer by establishing a common encryption scheme, defining a unique control number known to both the target client computer and the server computer, and defining a unique network identifier for each of the server computer and target client computer.

32. The apparatus of claim 31 further comprising:
means for encoding the control number within the header of the advertisement message;
means for encrypting, in the server computer, the advertisement message using the common encryption scheme;
means for decrypting, in the target client computer, the encrypted advertisement message; and
means for validating the control number in the header.

33. The apparatus of claim 32 wherein the encryption scheme comprises a 128-bit key public key/private key encryption system.

34. The apparatus of claim 33 wherein the unique network identifier for the server computer corresponds to the sender identification of the server computer, and includes a serial number of the server computer.
